(19) United States
(12) Patent Application Publication
(10) Pub. No.: US 2025/0182544 A1
(43) Pub. Date: Jun. 5, 2025

(54) VEHICLE ACCIDENT ANALYSIS SYSTEM AND METHOD, AND USER TERMINAL

(71) Applicant: CP6 CO., LTD., Gyeonggi-do (KR)

(72) Inventors: JUN IL PARK, Seoul (KR); NAE HO SHIN, Gyeonggi-do (KR)

(21) Appl. No.: 18/845,037

(22) PCT Filed: Dec. 9, 2022
(86) PCT No.: PCT/KR2022/020045

§ 371 Date: Sep. 9, 2024

(30) Foreign Application Priority Data
Mar. 8, 2022 (KR) 10-2022-0029532
Apr. 14, 2022 (KR) 10-2022-0046255

(51) Int. Cl. G07C 5/08

(52) U.S. Cl. CPC G07C 5/0866

(57) ABSTRACT

vehicle accident analysis system includes a vehicle accident analysis server which includes a wired/wireless communication function to acquire autonomous driving record data and image data of an autonomous driving vehicle, generates and provides vehicle accident analysis data including accident analysis data and accident situation data obtained by synchronizing the acquired autonomous driving record data and image data on the basis of time information included in each of the acquired autonomous driving record data and image data, and generates vehicle accident analysis data so that when requested to be reproduced, the autonomous driving record data and the image data are reproduced to correspond to each other on the basis of a reproduction requested time and a user terminal which includes a wired/wireless communication function, and receives vehicle accident analysis data to output same on a screen according to a reproduction request signal input by a user.

### CROSS REFERENCE TO RELATED APPLICATIONS AND CLAIM OF PRIORITY

This application claims benefit under 35 U. S.C. 119, 120, 121, or 365(c), and is a National Stage entry from International Application No. PCT/KR2022/020045 filed on Dec. 9, 2022, which claims priority to the benefit of Korean Patent Application Nos. 10-2022-0046255 filed on Apr. 14, 2022 and 10-2022-0029532 filed on Mar. 8, 2022 in the Korean Intellectual Property Office, the entire contents of which are incorporated herein by reference.

### BACKGROUND

### 1. Technical Field

The disclosed embodiments relate to a vehicle accident analysis system and method and a user terminal.

### 2. Background Art

As the number of vehicle drivers increases, new vehicles having various additional functions are being developed every year to improve driver's convenience.

For example, an autonomous driving vehicle implements autonomous driving using a lane keeping assist system, which provides technology that prevents a vehicle from leaving its lane while driving, a lane departure warning system, which provides technology that detects a lane change without turning on a turn signal and notifies the driver a notification, and operates an active vehicle safety system, and adaptive cruise control or smart cruise control, which provides technology that automatically maintains an appropriate distance from a vehicle in front using a radar mounted on the front of the vehicle, etc. and provide a service that allows the vehicle to travel to its destination on its own without the driver having to operate a steering wheel, accelerator pedal, or brakes.

While the above-described autonomous driving vehicle is rapidly increasing in sales due to the convenience of a driver, traffic accidents often occur due to a road situation in which various unpredictable situations occur, a situation in which the vehicle is traveling together with non-autonomous driving vehicles, and a malfunction of an autonomous driving vehicle, and the like.

### SUMMARY

The disclosed embodiments are intended to provide a vehicle accident analysis system and method and a user terminal for clearly and easily grasping a cause of an accident when a traffic accident occurs in an autonomous driving vehicle.

A vehicle accident analysis system according to an embodiment includes a vehicle accident analysis server which is provided with a wired/wireless communication function to acquire autonomous driving record data and image data of an autonomous driving vehicle, generates and provides vehicle accident analysis data including accident analysis data and accident situation data which are obtained by synchronizing the acquired autonomous driving record data and image data on the basis of time information included in each of the acquired autonomous driving record data and image data, and generates vehicle accident analysis data so that when a reproduction request is issued for any one of the autonomous driving record data and the image data, the autonomous driving record data and the image data are reproduced to correspond to each other on the basis of a reproduction requested time and a user terminal which is provided with a wired/wireless communication function, and receives vehicle accident analysis data to output the vehicle accident analysis data on a screen according to a reproduction request signal input by a user.

In addition, the vehicle accident analysis server may synchronize the autonomous driving record data and the image data with each other based on the time information when the time information of the autonomous driving record data and the image data is both global positioning system (GPS) time.

In addition, the vehicle accident analysis server may set a time difference with second time information of the image data as a correction time based on first time information of the autonomous driving record data to correct the second time information and then synchronize the autonomous driving record data and the image data with each other, when a time difference occurs between the first time information, which is a GPS time, and the second time information, which is a non-GPS time.

In addition, the vehicle accident analysis server may grasp a time point of accident occurrence from the image data through machine learning using an accident identification algorithm, correct timelines of the autonomous driving record data and the image data to correspond to each other by matching second time information of the image data at the time point of accident occurrence with first time information of the autonomous driving record data at a time point of accident occurrence in the autonomous driving record data, and then synchronize the autonomous driving record data and the moving image data, when different standard times are applied to the autonomous driving record data of which the first time information is a GPS time and the image data of which the second time information is a non-GPS time.

In addition, the autonomous driving record data may be data acquired through vehicle sensors including a GPS device, a lidar, a radar, an ultrasonic sensor, a computer system, and a photographing device mounted on the autonomous driving vehicle.

In addition, the autonomous driving record data may include at least one of an ON/OFF of an autonomous driving function, a takeover request, a takeover, a minimal risk maneuver, faults, a speed, a lane change, deceleration, a field of view, and a distance between vehicles.

In addition, the user terminal may reproduce at least one item of the autonomous driving record data corresponding to a reproduction time of the image data when reproducing the image data, when a reproduction request is issued for any one of the autonomous driving record data and the image data.

In addition, the autonomous driving record data and the image data may include identification information and vehicle model information of the corresponding autonomous driving vehicle, respectively.

In addition, the image data may include at least one of moving image data photographed by a vehicle image recording device provided in the autonomous driving vehicle, moving image data photographed by a vehicle image recording device provided in another vehicle, moving image data photographed by a traffic image recording device around the autonomous driving vehicle, and a still image and moving image photographed by a mobile communication terminal.

In addition, the autonomous driving record data and image data when the accident occurs may include data before and after a preset time based on a time point when an accident occurs in the autonomous driving vehicle.

A user terminal according to another embodiment is provided with a wired/wireless communication function to acquire autonomous driving record data and image data of an autonomous driving vehicle, generates vehicle accident analysis data including accident analysis data and accident situation data which are obtained by synchronizing the acquired autonomous driving record data and image data on the basis of time information included in each of the acquired autonomous driving record data and image data, and outputs the autonomous driving record data and the image data are reproduced to correspond to each other on a screen on the basis of a reproduction requested time when a reproduction request is issued for any one of the autonomous driving record data and the image data.

A vehicle accident analysis method according to still another embodiment includes acquiring, by a vehicle accident analysis server, autonomous driving record data and image data of an autonomous driving vehicle, generating and providing, by the vehicle accident analysis server, vehicle accident analysis data including accident analysis data and accident situation data which are obtained by synchronizing the acquired autonomous driving record data and image data on the basis of time information included in each of the acquired autonomous driving record data and image data, and outputting, by a terminal, the vehicle accident user analysis data on a screen according to a reproduction request signal input by a user, and in the generating of the vehicle accident analysis data, and vehicle accident analysis data is generated so that when a reproduction request is issued for any one of the autonomous driving record data and the image data, the autonomous driving record data and the image data are reproduced to correspond to each other on the basis of a reproduction requested time.

In addition, the generating of the vehicle accident analysis data may further include generating at least one accident analysis data related to the autonomous driving vehicle based on the autonomous driving record data, and in the generating of the vehicle accident analysis data, the accident analysis data may be included and generated when the vehicle accident analysis data is generated.

In addition, in the generating of the vehicle accident analysis data, a time difference with second time information of the image data may be set as a correction time based on first time information of the autonomous driving record data to correct the second time information and then the autonomous driving record data and the image data may be synchronized with each other, when a time difference occurs between the first time information, which is a GPS time, and the second time information, which is a non-GPS time.

In addition, in the generating of the vehicle accident analysis data, a time point of accident occurrence may be grasped from the image data through machine learning using an accident identification algorithm, timelines of the autonomous driving record data and the image data are corrected to correspond to each other by matching second time information of the image data at the time point of accident occurrence with first time information of the autonomous driving record data at a time point of accident occurrence in the autonomous driving record data, and then the autonomous driving record data may be synchronized with the moving image data, when different standard times are applied to the autonomous driving record data of which the first time information is a GPS time and the image data of which the second time information is a non-GPS time.

According to the disclosed embodiments, since autonomous driving record data and video data when an accident occurs are synchronized and provided according to the timeline, the effect of being able to clearly and easily grasp a cause of the accident in the event of a traffic accident in an autonomous driving vehicle can be expected.

In addition, the disclosed embodiments can clearly determine a proportion of responsibility for the cause of the accident among the driver and autonomous driving function when a traffic accident occurs in an autonomous driving vehicle.

In addition, since the disclosed embodiments can synchronize and simultaneously check autonomous driving record data and image data for traffic accident situations that occur in an autonomous driving vehicle, it is possible for insurance companies to more easily perform accident processing, including accident cause analysis.

### BRIEF DESCRIPTION OF THE DRAWINGS

FIG. 1 is a block diagram illustrating a vehicle accident analysis system according to an embodiment.

FIGS. 2 to 3 are exemplary diagrams illustrating a vehicle accident analysis method according to an embodiment.

FIG. 4 is a block diagram illustrating a vehicle accident analysis system according to another embodiment.

FIG. 5 is a flowchart illustrating a vehicle accident analysis method according to an embodiment.

FIG. 6 is a block diagram for illustratively describing a computing environment including a computing device according to an embodiment.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or operators. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

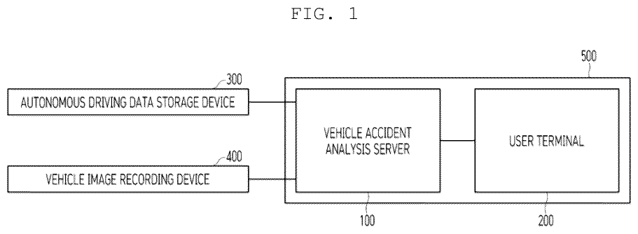

FIG. 1 is a block diagram illustrating a vehicle accident analysis system according to an embodiment.

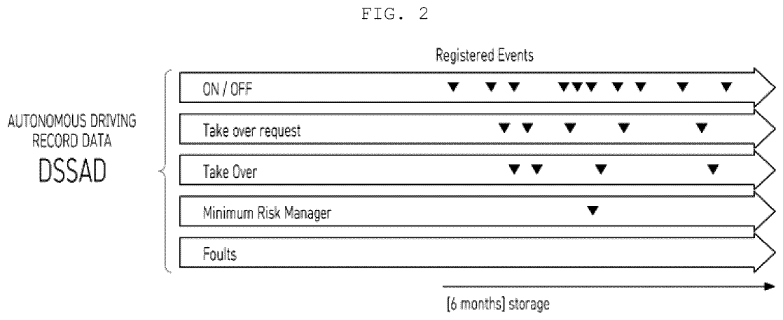

Hereinafter, a vehicle accident analysis method according to an embodiment will be described with reference to FIGS. 2 and 3, which are exemplary diagrams for describing the method.

Referring to FIG. 1, a vehicle accident analysis system 500 includes a vehicle accident analysis server 100 and a user terminal 200.

To describe in more detail, the vehicle accident analysis server 100 may be provided with a wired/wireless communication function to acquire autonomous driving record data and image data of an autonomous driving vehicle (not illustrated), and generate and provide vehicle accident analysis data including accident analysis data and accident situation data which are obtained by synchronizing the acquired autonomous driving record data and image data on the basis of time information included in each of the acquired autonomous driving record data and image data.

In this case, synchronizing the autonomous driving record data and the image data based on time information may mean matching the autonomous driving record data and the image data according to a timeline according to the same time standard. When a reproduction request is issued for any one of the autonomous driving record data and the image data, autonomous driving record data and image data corresponding to the reproduction requested time may be output on a screen at the same time.

In addition, the accident analysis data may mean data analyzed according to a preset accident analysis algorithm based on autonomous driving record data or video data. In this case, the accident analysis algorithm may mean a previously trained algorithm that can grasp items necessary to grasp an accident situation. For example, the accident analysis data may include an accident date, an accident site weather, a surrounding traffic situation at the time of an accident, whether there is an autonomous driving at the date and time of an accident, a vehicle speed, and the like, but is not limited thereto, and may be added and changed according to needs of an operator.

The above-described autonomous driving record data may be data acquired through vehicle sensors including a GPS device, a lidar, a radar, an ultrasonic sensor, a computer system, and a photographing device mounted on the autonomous driving vehicle. In this case, an autonomous driving data storage device 300 illustrated in FIG. 1 may be mounted on an autonomous driving vehicle to collect data (e.g., vehicle location, speed, steering, sensor data, image information, etc.) from a vehicle sensor including a GPS device, a lidar, a radar, an ultrasonic sensor, a computer system, and a photographing device. For example, the autonomous driving data storage device 300 may be a data storage system for automated driving (DSSAD).

Specifically, referring to FIG. 2, the autonomous driving record data may include at least one of ON/OFF of an autonomous driving function, a takeover request, a takeover, a minimal risk maneuver, and faults. In addition, the autonomous driving record data may further include at least one of a vehicle speed, a lane change, deceleration, a field of view, and a distance between vehicles. As illustrated in FIG. 2, the autonomous driving data storage device 300 may store an occurrence event for the above-described items for a specific period (e.g., 6 months).

The image data may include at least one of moving image data photographed by a vehicle image recording device provided in the autonomous vehicle, moving image data photographed by a vehicle image recording device installed in another vehicle, moving image data photographed by a traffic image recording device around the autonomous vehicle, and a still image and a moving image photographed by a user's mobile communication terminal. For example, the user's mobile communication terminal may be a mobile phone of the driver, passenger, or people around after an accident.

Meanwhile, the image data may be collected in the vehicle accident analysis server 100 as a memory card mounted on the vehicle image recording device 400 is collected by an insurance company manager, or may be collected through wired/wireless communication functions of an image providing side including the vehicle image recording device 400, the traffic image recording device, and the mobile communication terminal.

The above-described vehicle image recording device 400 may be a black box, but is not limited thereto, and may be any device mounted outside and inside the autonomous vehicle and capable of photographing a moving image. In this case, the vehicle image recording apparatus 400 may be assigned identification information and provided together when the photographed image data is provided.

In addition, the traffic video recording device may be a closed-circuit television (CCTV) that collects traffic information.

The autonomous driving record data and the image data may each include identification information and vehicle type information of the corresponding autonomous vehicle.

The autonomous driving record data and image data at the time of accident occurrence may include data before and after a preset time based on a time point when the accident occurred in the autonomous driving vehicle.

When a reproduction request is generated for any one of the autonomous driving record data and the image data, the vehicle accident analysis server 100 may generate vehicle accident analysis data so that the autonomous driving record data and the image data are reproduced to correspond to each other on the basis of a reproduction requested time.

As an example, when the time information of the autonomous driving record data and image data is both the global positioning system (GPS) time, the vehicle accident analysis server 100 may synchronize the autonomous driving record data and the image data with each other based on the time information.

For example, when the time information of a time point of accident occurrence of the autonomous driving record data and image data is both 2:00 PM in GPS time, the vehicle accident analysis server 100 may determine that the time standards of the autonomous driving record data and the image data are the same, and synchronize them with each other based on the time information included in each of the autonomous driving record data and the image data.

The above-described time standard may refer to a time applied to the corresponding data. For example, the time standard may be a time to which a GPS time is applied, may be a time which is input through a manual operation of a user, or may be a time which is set in advance in a device.

As another example, when a time difference occurs between the first time information, which is a GPS time, and the second time information, which is a non-GPS time, the vehicle accident analysis server 100 may set the time difference with second time information of the image data as a correction time based on first time information of the autonomous driving record data to correct the second time information and then synchronize the autonomous driving record data and the image data with each other.

For example, when the first time of the time point of accident occurrence in the autonomous driving record data is 2 PM in GPS time and the second time of the time point of accident occurrence of the image data is 2:30 PM in non-GPS time, the vehicle accident analysis server 100 may set the correction time to 30 minutes, which is the time difference between the first time and the second time, and correct the second time 30 minutes earlier based on the first time so that the time standards of the first time and the second time are the same. In this case, the time difference of the second time of the image data may occur for reasons such as an initial time setting error, a phenomenon in which time is gradually delayed after the initial time setting, and time initialization due to ON/OFF of the vehicle video recording device 400. In this case, the vehicle accident analysis server 100 may grasp that a time difference occurs between the autonomous driving record data and the image data when the time standards of the first time and the second time are different from each other.

As another example, when different standard times are applied to the autonomous driving record data of which first time information is a GPS time and the image data of which second time information is a non-GPS time, the vehicle accident analysis server 100 may grasp a time point of accident occurrence from the image data through machine learning using an accident identification algorithm, correct timelines of the autonomous driving record data and the image data to correspond to each other by matching second time information of the image data at the time point of accident occurrence with first time information of the autonomous driving record data at the time point of accident occurrence, and then synchronize the autonomous driving record data and the moving image data.

For example, the vehicle accident analysis server 100 may grasp a time point of accident occurrence from the image data through machine learning using an accident identification algorithm and check second time information (e.g., 2:30 PM) at the time point of accident occurrence.

The vehicle accident analysis server 100 may check first time information (e.g., 2 PM) at the time point of accident occurrence from the autonomous driving record data. The vehicle accident analysis server 100 may match the second time information at the time point of accident occurrence of the image data with the first time information at the time point of accident occurrence of the autonomous driving record data to synchronize the timelines of the autonomous driving record data and the image data to correspond to each other. That is, after synchronization, the second time information at the time point of accident occurrence of the image data is corrected to 2 PM, and the second time information before and after the time point of accident occurrence is also corrected based on the corrected second time information at the time point of accident occurrence.

In this case, the accident grasp algorithm may mean an algorithm capable of extracting a time point of accident occurrence from image data by performing learning processing based on various existing accident images.

The user terminal 200 may be provided with a wired or wireless communication function and configured to receive vehicle accident analysis data 100 and output the vehicle accident analysis data 100 on a screen according to a reproduction request signal input by the user.

As illustrated in FIG. 3, the user terminal 200 may reproduce at least one item of the autonomous driving record data corresponding to a reproduction time of the image data when reproducing the image data, when a reproduction request is issued for any one of autonomous driving record data A and image data B. That is, the user may simultaneously check the image data (the moving image at the accident time point) and the autonomous driving record data (DSSAD at the accident time point) that occurred at the same time on the screen of the user terminal 200. When a request for reproducing autonomous driving record data or image data corresponding to a specific time rather than autonomous driving record data or image data corresponding to the beginning of the accident time point is generated by the user, the user terminal 200 may output the image data and the autonomous driving record data corresponding to the time at which the reproduction request is generated on the screen. Accordingly, a user, including an insurance company person, can expect the effect of being able to quickly check image data for the time he or she is intended to check and autonomous driving record data matching the image data, and to more quickly grasp the cause of an accident by comparing and analyzing both data.

The above-described user terminal 200 may include a portable mobile communication terminal having a mobile communication function including a mobile phone, a tablet, and the like, and a wired terminal such as a desktop.

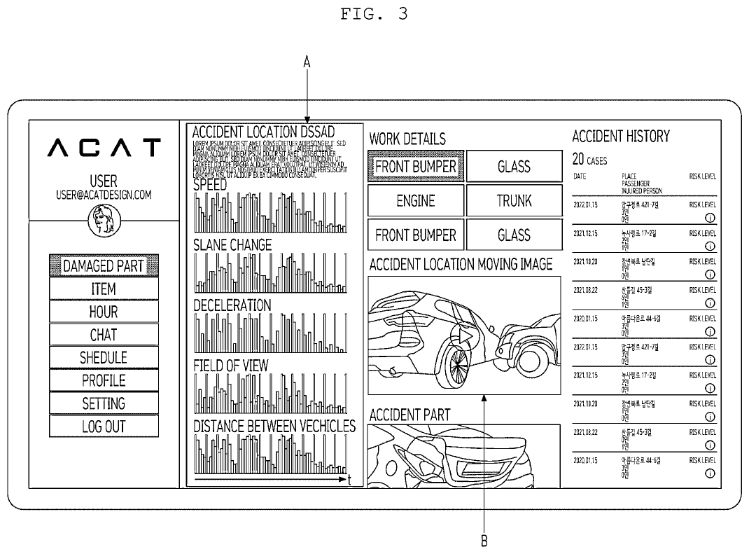

FIG. 4 is a block diagram for describing a vehicle accident analysis system according to another embodiment.

A user terminal 200 disclosed below is intended to describe a case in which the user terminal 200 may independently implement the roles of the vehicle accident analysis server 100 and the user terminal 200 illustrated in FIG. 1. Accordingly, although omitted for convenience of description, it is natural that the user terminal 200 may perform all of the roles of the vehicle accident analysis server 100 illustrated in FIG. 1.

Referring to FIG. 4, the user terminal 200 may be provided with a wired/wireless communication function to acquire autonomous driving record data and image data of an autonomous driving vehicle and generate vehicle accident analysis data including accident analysis data and accident situation data which are obtained by synchronizing the acquired autonomous driving record data and image data on the basis of time information included in each of the acquired autonomous driving record data and image data.

The user terminal 200 may output the autonomous driving record data and the image data on a screen (not illustrated) in correspondence with each other on the basis of a reproduction requested time, when a reproduction request is issued for any one of the autonomous driving record data and the image data.

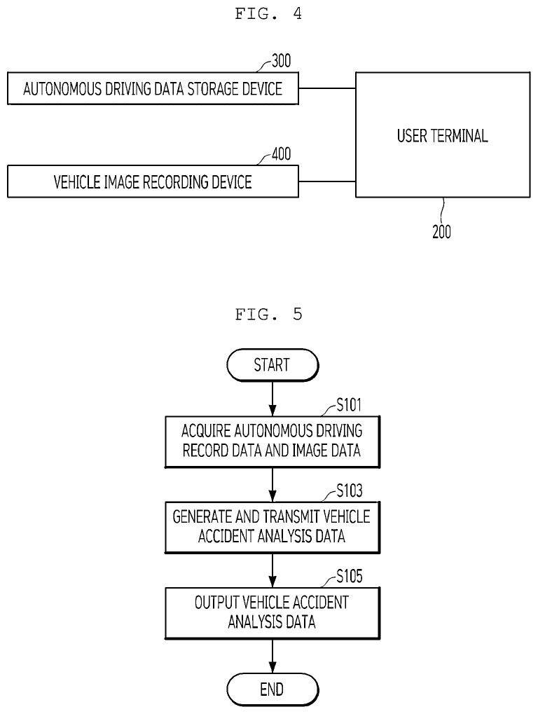

FIG. 5 is a flowchart for describing a vehicle accident analysis method according to an embodiment. The method illustrated in FIG. 5 may be performed, for example, by the vehicle accident analysis system 500 described above. In the illustrated flowchart, although the method is described by being divided into a plurality of steps, at least some of the steps may be performed out of order, performed by being combined with other steps, omitted, performed by being divided into detailed steps, or performed by being added with one or more steps not illustrated.

In step 101, the vehicle accident analysis server 100 may acquire autonomous driving record data and image data of the autonomous driving vehicle.

The autonomous driving data storage device 300 may be mounted on an autonomous driving vehicle and may collect data (e.g., vehicle location, speed, steering, sensor data, image information, etc.) from vehicle sensors including a GPS device, a lidar, a radar, an ultrasonic sensor, computer system, and a photographing device. For example, the autonomous driving data storage device 300 may be a data storage system for automated driving (DSSAD).

Specifically, the autonomous driving record data may include at least one of items of ON/OFF of an autonomous driving function, a takeover request, a takeover, a minimal risk maneuver, and faults. In addition, the autonomous driving record data may additionally include at least one of items of a vehicle speed, a lane change, deceleration, a field of view, and a distance between vehicles. As illustrated in FIG. 2, the autonomous driving data storage device 300 may store an occurrence event for the above-described item for a specific period (e.g., 6 months).

The image data may include at least one of moving image data photographed by the vehicle image recording device 400 provided in the autonomous vehicle, moving image data photographed by a vehicle image recording device provided in another vehicle, moving image data photographed by a traffic image recording device around the autonomous vehicle, and a still image and a moving image photographed by a user's mobile communication terminal. For example, the user's mobile communication terminal may be a mobile phone of a driver, a passenger, or surrounding people after an accident occurs.

Meanwhile, the image data may be collected in the vehicle accident analysis server 100 as a memory card mounted on the vehicle image recording device 400 is collected by an insurance company manager, or may be collected through wired/wireless communication functions of an image providing side including the vehicle image recording device 400, the traffic image recording device, and the mobile communication terminal.

In step 103, the vehicle accident analysis server 100 may generate and provide vehicle accident analysis data including accident analysis data and accident situation data which are obtained by synchronizing the acquired autonomous driving record data and image data on the basis of time information included in each of the acquired autonomous driving record data and image data.

In this case, the vehicle accident analysis server 100 may generate vehicle accident analysis data so that when a reproduction request is issued for any one of the autonomous driving record data and the image data, the autonomous driving record data and the image data are reproduced to correspond to each other on the basis of a reproduction requested time.

As an example, the vehicle accident analysis server 100 may synchronize the autonomous driving record data and the image data with each other based on the time information when the time information of the autonomous driving record data and image data is both global positioning system (GPS) time.

The above-described time standard may refer to a time applied to the corresponding data. For example, the time standard may be a time to which a GPS time is applied, may be a time which is input through a manual operation of a user, or may be a time which is set in advance in a device.

As another example, the vehicle accident analysis server 100 may set a time difference with second time information of the image data as a correction time based on first time information of the autonomous driving record data to correct the second time information and then synchronize the autonomous driving record data and the image data with each other, when a time difference occurs between the first time information, which is a GPS time, and the second time information, which is a non-GPS time.

As another example, the vehicle accident analysis server 100 may grasp a time point of accident occurrence from the image data through machine learning using an accident identification algorithm, correct timelines of the autonomous driving record data and the image data to correspond to each other by matching second time information of the image data at the time point of accident occurrence with first time information of the autonomous driving record data at a time point of accident occurrence in the autonomous driving record data, and then synchronize the autonomous driving record data and the moving image data, when different standard times are applied to the autonomous driving record data of which the first time information is a GPS time and the image data of which the second time information is a non-GPS time.

In this case, the accident identification algorithm may mean an algorithm capable of extracting the time of accident occurrence from image data by performing learning processing based on various existing accident images.

Meanwhile, in step 103, the vehicle accident analysis server 100 may generate at least one accident analysis data related to an autonomous driving vehicle based on the autonomous driving record data. When generating vehicle accident analysis data, the vehicle accident analysis server 100 may generate the vehicle accident analysis data including the accident analysis data.

In step 105, the user terminal 200 may output the vehicle accident analysis data on the screen according to a reproduction request signal input by the user.

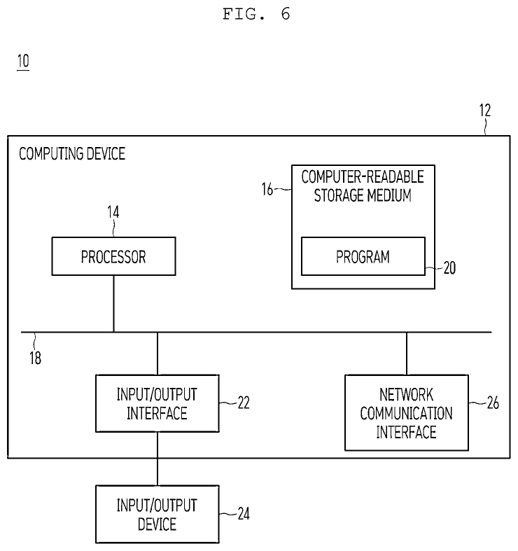

FIG. 6 is a block diagram for illustratively describing a computing environment including a computing device according to an embodiment. In the illustrated embodiment, respective components may have different functions and capabilities other than those described below, and may include additional components in addition to those described below.

The illustrated computing environment 10 includes a computing device 12. In one embodiment, the computing device 12 may be the vehicle accident analysis server 100. In addition, the computing device 12 may be the user terminal 200.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output device 24 may be connected to other components of the computing device 12 through the input/output interface 22. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

Although representative embodiments of the present disclosure have been described in detail, a person skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents to the claims.

1. A vehicle accident analysis system comprising:
a vehicle accident analysis server provided with a wired/wireless communication function to acquire autonomous driving record data and image data of an autonomous driving vehicle, the vehicle accident analysis server configured to generate and provide vehicle accident analysis data including accident analysis data and accident situation data obtained by synchronizing the acquired autonomous driving record data and image data on the basis of time information included in each of the acquired autonomous driving record data and image data, and generate vehicle accident analysis data so that when a reproduction request is issued for any one of the autonomous driving record data and the image data, the autonomous driving record data and the image data are reproduced to correspond to each other on the basis of a reproduction requested time; and
a user terminal provided with a wired/wireless communication function, the user terminal configured to receive vehicle accident analysis data to output the vehicle accident analysis data on a screen according to a reproduction request signal input by a user.

2. The vehicle accident analysis system of claim 1, wherein the vehicle accident analysis server synchronizes the autonomous driving record data and the image data with each other based on the time information when the time information of the autonomous driving record data and the image data is both global positioning system (GPS) time.

3. The vehicle accident analysis system of claim 1, wherein the vehicle accident analysis server is configured to set a time difference with second time information of the image data as a correction time based on first time information of the autonomous driving record data to correct the second time information and then synchronize the autonomous driving record data and the image data with each other, when a time difference occurs between the first time information, which is a GPS time, and the second time information, which is a non-GPS time.

4. The vehicle accident analysis system of claim 1, wherein the vehicle accident analysis server is configured to:
grasp a time point of accident occurrence from the image data through machine learning using an accident identification algorithm;
correct timelines of the autonomous driving record data and the image data to correspond to each other by matching second time information of the image data at the time point of accident occurrence with first time information of the autonomous driving record data at a time point of accident occurrence in the autonomous driving record data; and
then synchronize the autonomous driving record data and the moving image data, when different standard times are applied to the autonomous driving record data of which the first time information is a GPS time and the image data of which the second time information is a non-GPS time.

5. The vehicle accident analysis system of claim 1, wherein the autonomous driving record data is data acquired through vehicle sensors including a GPS device, a lidar, a radar, an ultrasonic sensor, a computer system, and a photographing device mounted on the autonomous driving vehicle.

6. The vehicle accident analysis system of claim 1, wherein the autonomous driving record data includes at least one of an ON/OFF of an autonomous driving function, a take over request, a take over, a minimal risk maneuver, faults, a speed, a lane change, deceleration, a field of view, and a distance between vehicles.

7. The vehicle accident analysis system of claim 6, wherein the user terminal is configured to reproduce at least one item of the autonomous driving record data corresponding to a reproduction time of the image data when reproducing the image data, when a reproduction request is issued for any one of the autonomous driving record data and the image data.

8. The vehicle accident analysis system of claim 1, wherein the autonomous driving record data and the image data include identification information and vehicle model information of the corresponding autonomous driving vehicle, respectively.

9. The vehicle accident analysis system of claim 1, wherein the image data includes at least one of moving image data photographed by a vehicle image recording device provided in the autonomous driving vehicle, moving image data photographed by a vehicle image recording device provided in another vehicle, moving image data photographed by a traffic image recording device around the autonomous driving vehicle, and a still image and moving image photographed by a mobile communication terminal.

10. The vehicle accident analysis system of claim 1, wherein the autonomous driving record data and image data when the accident occurs include data before and after a preset time based on a time point when an accident occurs in the autonomous driving vehicle.

11. A user terminal provided with a wired/wireless communication function to acquire autonomous driving record data and image data of an autonomous driving vehicle, the user terminal configured to:
generate vehicle accident analysis data including accident analysis data and accident situation data which are obtained by synchronizing the acquired autonomous driving record data and image data on the basis of time information included in each of the acquired autonomous driving record data and image data; and
output the autonomous driving record data and the image data are reproduced to correspond to each other on a screen on the basis of a reproduction requested time when a reproduction request is issued for any one of the autonomous driving record data and the image data.

12. A vehicle accident analysis method comprising:
acquiring, by a vehicle accident analysis server, autonomous driving record data and image data of an autonomous driving vehicle;
generating and providing, by the vehicle accident analysis server, vehicle accident analysis data including accident analysis data and accident situation data which are obtained by synchronizing the acquired autonomous driving record data and image data on the basis of time information included in each of the acquired autonomous driving record data and image data; and
outputting, by a user terminal, the vehicle accident analysis data on a screen according to a reproduction request signal input by a user,
wherein, in the generating of the vehicle accident analysis data, vehicle accident analysis data is generated so that when a reproduction request is issued for any one of the autonomous driving record data and the image data, the autonomous driving record data and the image data are reproduced to correspond to each other on the basis of a reproduction requested time.

13. The vehicle accident analysis method of claim 12, wherein the generating of the vehicle accident analysis data further includes generating at least one accident analysis data related to the autonomous driving vehicle based on the autonomous driving record data, and
when the vehicle accident analysis data is generated, the vehicle accident analysis data is generated including the accident analysis data.

14. The vehicle accident analysis method of claim 12, wherein, in the generating of the vehicle accident analysis data, a time difference with second time information of the image data is set as a correction time based on first time information of the autonomous driving record data to correct the second time information and then the autonomous driving record data and the image data is synchronized with each other, when a time difference occurs between the first time information, which is a GPS time, and the second time information, which is a non-GPS time.

15. The vehicle accident analysis method of claim 12, wherein, in the generating of the vehicle accident analysis data, a time point of accident occurrence is grasped from the image data through machine learning using an accident identification algorithm, timelines of the autonomous driving record data and the image data are corrected to correspond to each other by matching second time information of the image data at the time point of accident occurrence with first time information of the autonomous driving record data at a time point of accident occurrence in the autonomous driving record data, and then the autonomous driving record data is synchronized with the moving image data, when different standard times are applied to the autonomous driving record data of which the first time information is a GPS time and the image data of which the second time information is a non-GPS time.
